(19) United States
(12) Patent Application Publication
(10) Pub. No.: US 2023/0177385 A1
(43) Pub. Date: Jun. 8, 2023

(54) FEDERATED MACHINE LEARNING BASED ON PARTIALLY SECURED SPATIO-TEMPORAL DATA

(71) Applicant: International Business Machines Corporation, Armonk, NY (US)

(72) Inventors: Lokesh Nagalapatti, Chennai (IN); Sambaran Bandyopadhyay, Hooghly (IN); Ruhi Sharma Mittal, Bengaluru (IN); Ramasuri Narayanam, ANDHRA PRADESH (IN)

(21) Appl. No.: 17/545,573

(22) Filed: Dec. 8, 2021

(51) Int. Cl. G06N 20/00; G06N 5/02

(52) U.S. Cl. CPC G06N 20/00; G06N 5/02

(57) ABSTRACT

Methods, systems, and computer program products for federated machine learning based on partially secured spatio-temporal data are provided herein. A computer-implemented method includes obtaining temporal data from a plurality of distributed client devices in conjunction with a federated machine learning process, wherein at least a portion of the data comprises encoded private data and at least a portion of the data is public data; generating a spatio-temporal graph comprising nodes representing the plurality of distributed client devices, wherein the generating comprises identifying at least one pair of similar nodes based at least in part on the public data and adding an edge to the spatio-temporal graph between the pair of similar nodes; and aligning encoders of at least two of the distributed client devices based on the spatio-temporal graph.

### BACKGROUND

The present application generally relates to information technology and, more particularly, to machine learning (ML) techniques.

Federated learning is a ML technique that trains a software model in a decentralized manner. For example, a federated learning process may include training local models at multiple decentralized nodes (e.g., devices or servers) using local training data. A centralized node can store a global version of the model, which is updated using the aggregated training results from at least a portion of the decentralized nodes without a need to collect the local training data.

### SUMMARY

In one embodiment of the present disclosure, techniques for federated machine learning based on partially secured spatio-temporal data are provided. An exemplary computer-implemented method includes obtaining temporal data from a plurality of distributed client devices in conjunction with a federated machine learning process, wherein at least a portion of the data comprises encoded private data and at least a portion of the data is public data; generating a spatio-temporal graph comprising nodes representing the plurality of distributed client devices, wherein the generating comprises identifying at least one pair of similar nodes based at least in part on the public data and adding an edge to the spatio-temporal graph between the pair of similar nodes; and aligning encoders of at least two of the distributed client devices based at least in part on the spatio-temporal graph.

Another embodiment of the present disclosure or elements thereof can be implemented in the form of a computer program product tangibly embodying computer readable instructions which, when implemented, cause a computer to carry out a plurality of method steps, as described herein. Furthermore, another embodiment of the present disclosure or elements thereof can be implemented in the form of a system including a memory and at least one processor that is coupled to the memory and configured to perform noted method steps. Yet further, another embodiment of the present disclosure or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present disclosure will become apparent from the following detailed description of illustrative embodiments thereof, which is to be read in connection with the accompanying drawings.

### BRIEF DESCRIPTION OF THE DRAWINGS

FIG. 1 is a diagram illustrating a system architecture in accordance with exemplary embodiments;

FIG. 2 is a diagram showing a first alignment process in accordance with exemplary embodiments;

FIG. 3 is a diagram showing a second alignment process in accordance with exemplary embodiments;

FIG. 4 is a diagram showing a third alignment process in accordance with exemplary embodiments;

FIG. 5 is a flow diagram illustrating techniques for federated machine learning based on partially secured spatio-temporal data in accordance with exemplary embodiments;

FIG. 6 is a system diagram of an exemplary computer system on which at least one embodiment of the present disclosure can be implemented;

FIG. 7 depicts a cloud computing environment in accordance with exemplary embodiments; and

FIG. 8 depicts abstraction model layers in accordance with exemplary embodiments.

### DETAILED DESCRIPTION

Federated learning is helpful for building ML models in situations where data resides across multiple distributed nodes. For example, consider a case where training data, D_{Tr}, resides in a distributed manner such that D_{Tr}={D_{Tr}_{ᵢ}}. Assume there are a number, n, of clients and each client has a disjoint set of data points in a time series format. Accordingly, each D_{Tr}_{ᵢ} may be equal to {(xᵢ, yᵢ, tᵢ)|t=1, 2, . . . , T}. Each predictor, xᵢ, in can be denoted as (x₁, . . . , xₚᵤ, xₚᵣ₊₁, . . . xₚᵣ), where each training data point can include pr+pu features, where pr corresponds to private features and pu corresponds to public features. It is assumed that public features are not considered sensitive and can be disclosed publicly, whereas private features are considered highly sensitive, such as payment information (e.g., card numbers), personal data, customer data, and data protected by one or more rules or regulations. Accordingly, data relating to private features should be kept private to the node that possess it.

A collaborative ML model can be built to make local predictions at each client, where the model at a given client i is trained using data D_{Tr}_{ᵢ}. However, in a setting where each client has scarce data, it is appreciable to leverage data possessed by other nodes (e.g., neighboring nodes) when training the ML model. In such situations, the public features (i.e., x₁, . . . , xₚᵤ) can be shared as is, but sharing the private features (i.e., xₚᵣ₊₁, . . . xₚᵣ) should adhere to privacy restrictions.

Illustrative embodiments described herein provide techniques for building a ML model by unifying data that is geodesically distributed while enforcing constraints on data corresponding to private features. In at least some of the example embodiments, data distributed among a set of nodes is considered spatio-temporal data. The temporal aspect of the data is based on the fact that each client owns data that is time-series in nature. Accordingly, current predictions can depend on past observations. The spatial aspect of the data is based on the fact that a prediction by a given client shall be beneficially influenced by the predictions of neighboring clients, which, in general, are similar to the given client. This is often referred to as the homophily property in social networks and is also supported by the Distributional Hypothesis in Natural Language Processing (NLP) literature. One or more embodiments leverage the homophily property to define a distance measure that indicates similarity between distributed nodes. In at least some embodiments, publicly shared data is exploited to at least one of: identify similar nodes and align updates shared by the nodes to be incorporated in a message passing architecture, as described in more detail herein.

As a non-limiting example, consider a plurality of nodes (e.g., client devices), where each node represents a different field or farm in a geodescically separated area. The nodes may include one or more sensors for detecting certain features of the corresponding fields, such as, sensors for detecting soil moisture. Accordingly, each node generates or collects time-series data based on such sensors and, optionally, one or more other sources (e.g., online weather data). In this example, it is desirable to build an ML model that uses the past data to better predict the contemporary soil moisture. These predictions could help better equip farmers of the fields for different types of contingent situations. In order for the ML model to be useful, a distance measure is needed to add edges between appropriate nodes, which would enforce spatial dependencies on the predictions. One option is to treat nodes that are geodescically close as exhibiting similar characteristics of soil moisture. However, such an option does not account for the fact that nodes that are far apart may also exhibit similar characteristics. One or more embodiments identify similarities between public data (e.g., using embeddings of the public data, such as vector representations) of different nodes, which can then be used to add non-trivial edges to a spatio-temporal graph, which is used in conjunction with graph neural network (GNN) techniques to perform federated learning.

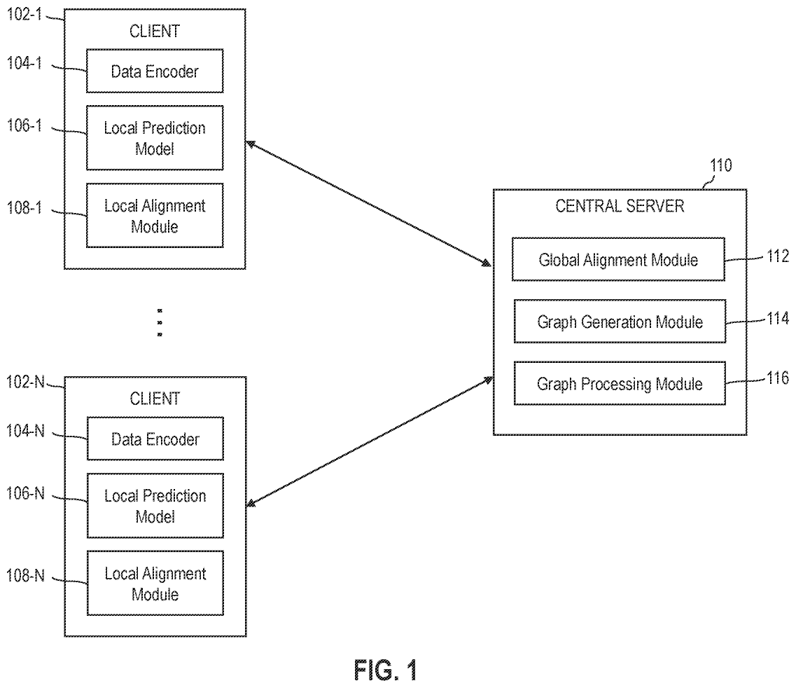

FIG. 1 is a diagram illustrating a system architecture in accordance with exemplary embodiments. By way of illustration, FIG. 1 depicts multiple clients 102-1, . . . , 102-N (collectively referred to as clients 102), and a central server 110. It is assumed each of the clients 102 collect and/or store temporal data including public data and private data. The clients 102 include corresponding data encoders, 104-1, . . . , 104-N (collectively data encoders 104), local prediction models 106-1, . . . , 106-N (collectively local prediction models 106-N), and local alignment modules 108-1, . . . , 108-N (collectively local alignment modules 108). Generally, a given one of the data encoders 104 encodes the temporal data collected at the corresponding client 102 into a vector representation, which can be provided to local prediction model 106-1 to make a prediction about the data (e.g., with respect to a target variable). The local alignment modules 108, in some embodiments, are used to align the data encoders 104 across the clients 102, as described in more detail elsewhere herein.

The central server 110 includes a global alignment module 112, a graph generation module 114, and a graph processing module 116. The global alignment module 112 is used to align at least a portion of the data encoders 104 of the clients 102. The graph generation module 114 generates a spatio-temporal graph based on the similarities between the clients 102, which are determined from the public data and the geodesic distance between the clients 102, for example.

In some embodiments, the graph processing module 116 can process the spatio-temporal graph to make predictions that assist the local prediction models 106. For example, the graph processing module 116 can generate predictions based at least in part on the public data that assist the local prediction models 106. The graph processing module 116, in some embodiments, is implemented as a GNN. The spatio-temporal graph may include nodes for each of the clients 102, and edges indicating similarity between pairs of the nodes. The spatio-temporal graph, in some embodiments, includes an adjacency matrix and attributes for at least a portion of the nodes. The adjacency matrix encodes similarity between nodes. If two nodes are similar, then the predictions at one node can be used to approximate the predictions at the other node.

The graph processing module 116 can output, for example, a desired quantity of interest (in the case of a supervised learning implementation) or predict node embeddings (in the case of an unsupervised learning implementation). The desired quantity can correspond to any feature that assists the local prediction models 106, for example. The unsupervised node embeddings can be used as additional inputs to the local prediction models 106, in which case, gradients for the GNN can be shared by the client.

Optionally, the graph processing module 116 can make a prediction about the target attribute (the same attribute predicted by the local prediction models 106).

The final loss (to be used to update the data encoders 104, for example) can be computed in different ways depending. For example, the final loss can be computed at each of the clients 102, in which case the GNN can attempt to compute embeddings that assist each local prediction network. The final loss can also be computed at the central server 110 using unsupervised embeddings trained based on negative sampling, or where the server predicts one or more auxiliary variables to further aid the local prediction models 106. Other options are also possible as long as the entire network is differentiable, for example.

As an example, the data encoders 104 may convert the temporal data into a neural digest vector using a recurrent neural network architecture, which can be shared with the central server 110 to be incorporated as a node feature in the graph. The neural digest vector may also be implemented (in conjunction with the node embedding shared by the server) by a decoder architecture of the local prediction model 106 to make the prediction.

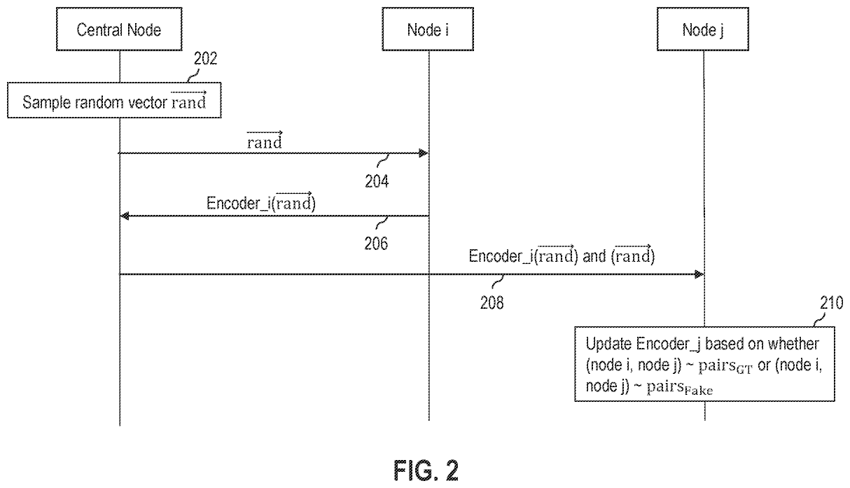

It is to be appreciated that the data encoders 104 of the clients 102 are independent, and thus embeddings produced by the data encoders 104 are not necessarily within the same vector space. Thus, in order to implement a message passing architecture, the data encoders 104 can be aligned based on the local alignment modules 108 and/or the global alignment module 112 while respecting privacy constraints, as described in further detail in conjunction with FIGS. 2-4, for example.

The techniques to align the data encoders 104 can include employing negative sampling. Negative sampling is a technique that attempts to maximize the similarity between pairs in a ground truth dataset and minimize the similarity between pairs in a fake dataset. In some embodiments of the present disclosure, the ground truth pairs are generated using the edges in the spatial graph generated and maintained by the central server 110. For example, the ground truth pairs may be sampled from the adjacency matrix, and the negative samples can be generated randomly. Hereafter, pairs_{GT} and pairs_{Fake} denote the ground truth and negative pairs, respectively.

Referring now to FIG. 2, this figure shows a diagram of a first alignment process in accordance with exemplary embodiments. In this example, the alignment process is shown for a central node (e.g., corresponding to central server 110) and a pair of nodes (node i and node j), which may correspond to clients 102. More specifically, step 202 includes the central node sampling a random vector, \vec{rand}, and step 204 includes sending the vector to node i. Node i encodes \vec{rand}, and sends the encoded vector (encoder_i(\vec{rand})) back to the central node at step 206. At step 208, the central node sends encoder_i(\vec{rand}) and (\vec{rand}) to node j. Step 210 includes updating the encoder at node j (encoder_j) based on whether (node i, node j) are in pairs_{GT} or pairs_{Fake}. For example, if (node i, node j) are in pairs_{GT}, then node j can update the encoder_j to increase the similarity of encoder_i(\vec{rand}) and encoder_j(\vec{rand}). If (node i, node j) are in pairs_{Fake}, then node j can update encoder_j to decrease the similarity between encoder_i(\vec{rand}) and encoder_j(\vec{rand})).

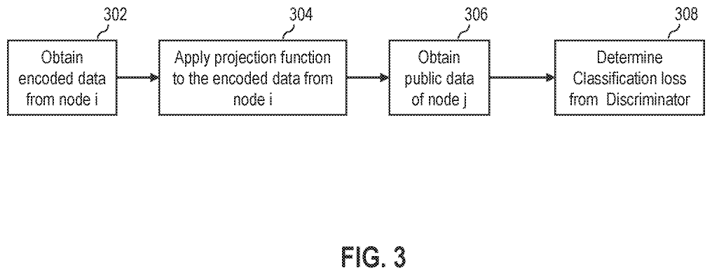

Referring now to FIG. 3, this figure shows a second alignment process in accordance with exemplary embodiments. Similar to FIG. 2, the alignment process is described with reference to a central node, node i, and node j. The process generally includes the central node learning a projection operator. More specifically, step 302 includes obtaining encoded data from node i. Step 304 includes obtaining applying a projection function to the encoded data from node i. The projection function can be a non-linear projection function that produces embeddings. Step 306 includes obtaining public data from node j. Step 308 includes determining classification loss using a discriminator model based on the public data from node j and the encoded data from node i. For example, pairs in pairs_{GT} can be labeled as 1, and pairs in pairs_{Fake} can be labeled as 0. Thus, the projection of the encoded data can be used as node features.

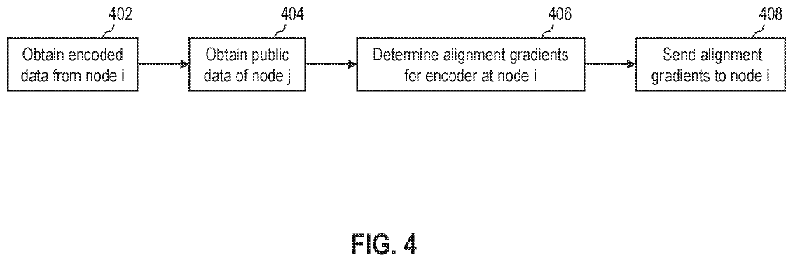

Referring now to FIG. 4, this figure shows a third alignment process in accordance with exemplary embodiments, which is described with reference to a central node, node i, and node j. Step 402 includes the central node obtaining encoded data from node i. Step 404 includes the central node obtaining public data from node j. Step 406 includes the central node determining alignment gradients for the encoder at node i using a discriminator model. Step 408 includes the central node sending the alignment gradients to node i to be used for updating its encoder.

Accordingly, the federated learning techniques described herein can be applied in situations where a part of data is private and used to update models locally, and another part of the data is public. This provides greater flexibility and is more broadly applicable than conventional federated learning techniques.

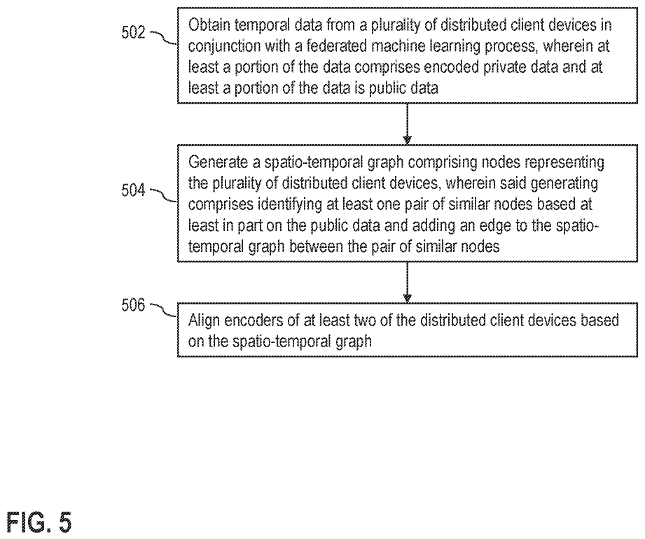

FIG. 5 is a flow diagram illustrating techniques in accordance with exemplary embodiments. Step 502 includes obtaining temporal data from a plurality of distributed client devices in conjunction with a federated machine learning process, wherein at least a portion of the data comprises encoded private data and at least a portion of the data is public data. Step 504 includes generating a spatio-temporal graph comprising nodes representing the plurality of distributed client devices, wherein the generating comprises identifying at least one pair of similar nodes based at least in part on the public data and adding an edge to the spatio-temporal graph between the pair of similar nodes. Step 506 includes aligning encoders of at least two of the distributed client devices based at least in part on the spatio-temporal graph.

The encoders of the at least two of the distributed client devices may produce embeddings of the private data in different vector spaces. A given one of the plurality of distributed client devices may include a machine learning model that generates a prediction based at least in part on embeddings output by an encoder of the given client device. The aligning may include applying a negative sampling process based at least in part on pairs of similar nodes that are identified in the spatio-temporal graph. The aligning may include: generating a random data sample; sending the random data sample to a first one of the plurality of distributed client devices; receiving an encoded version of the random data sample from the first distributed client device; and sending the encoded version and the random data sample to a second one of the plurality of distributed client devices, wherein the second distributed client device aligns its encoder based on the encoded version and the random data sample. The aligning may include: applying a projection function to the encoded private data of a given one of the distributed client device; and adding the output of the projection function as a feature to the node corresponding to the given distributed client device. The aligning may include: providing the encoded private data of a first one of the distributed client devices and the public data of a second one of the distributed client devices as input to a discriminator model to determine one or more alignment gradients; and sending the alignment gradients to at least one of the first and the second distributed client devices. The aligning may include: processing the spatio-temporal graph using a graph neural network. The process may be carried out by a central server in a message passing architecture.

The techniques depicted in FIG. 5 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the present disclosure, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 5 can be implemented via a computer program product that can include computer useable program code that is stored in a computer readable storage medium in a data processing system, and wherein the computer useable program code was downloaded over a network from a remote data processing system. Also, in an embodiment of the present disclosure, the computer program product can include computer useable program code that is stored in a computer readable storage medium in a server data processing system, and wherein the computer useable program code is downloaded over a network to a remote data processing system for use in a computer readable storage medium with the remote system.

An exemplary embodiment or elements thereof can be implemented in the form of an apparatus including a memory and at least one processor that is coupled to the memory and configured to perform exemplary method steps.

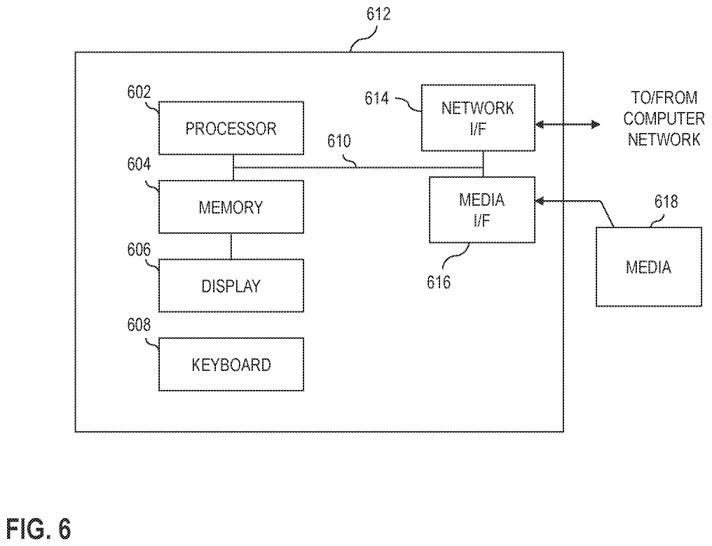

Additionally, an embodiment of the present disclosure can make use of software running on a computer or workstation. With reference to FIG. 6, such an implementation might employ, for example, a processor 602, a memory 604, and an input/output interface formed, for example, by a display 606 and a keyboard 608. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 602, memory 604, and input/output interface such as display 606 and keyboard 608 can be interconnected, for example, via bus 610 as part of a data processing unit 612. Suitable interconnections, for example via bus 610, can also be provided to a network interface 614, such as a network card, which can be provided to interface with a computer network, and to a media interface 616, such as a diskette or CD-ROM drive, which can be provided to interface with media 618.

Accordingly, computer software including instructions or code for performing the methodologies of the present disclosure, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 602 coupled directly or indirectly to memory elements 604 through a system bus 610. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 608, displays 606, pointing devices, and the like) can be coupled to the system either directly (such as via bus 610) or through intervening I/O controllers (omitted for clarity).

Network adapters such as network interface 614 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 612 as shown in FIG. 6) running a server program. It will be understood that such a physical server may or may not include a display and keyboard.

An exemplary embodiment may include a system, a method, and/or a computer program product at any possible technical detail level of integration. The computer program product may include a computer readable storage medium (or media) having computer readable program instructions thereon for causing a processor to carry out exemplary embodiments of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform embodiments of the present disclosure.

Embodiments of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 602. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings provided herein, one of ordinary skill in the related art will be able to contemplate other implementations of the components.

Additionally, it is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

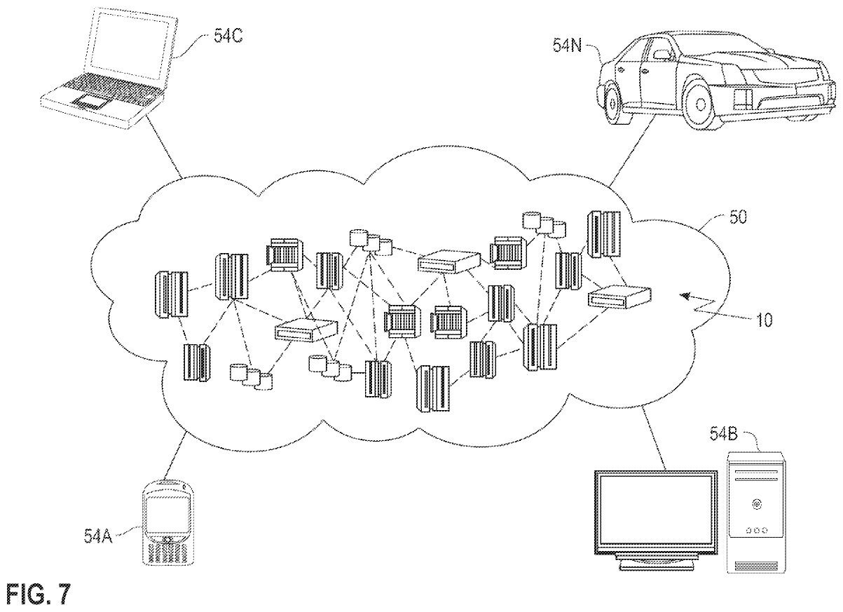

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

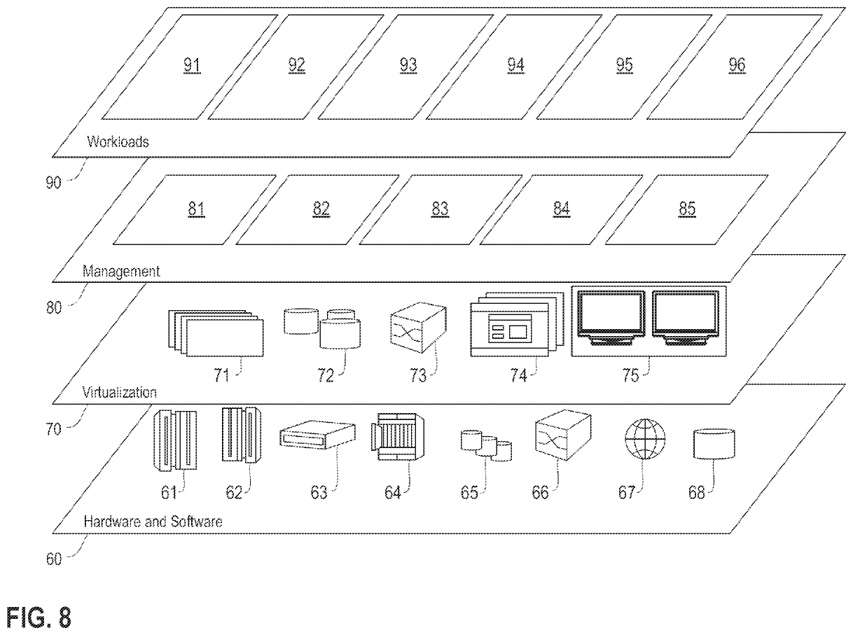

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources.

In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and federated learning based on partially secured spatio-temporal data 96, in accordance with the one or more embodiments of the present disclosure.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present disclosure may provide a beneficial effect such as, for example, enabling efficient federated learning techniques for partially secured data in a message passing architecture.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, the method comprising:
obtaining temporal data from a plurality of distributed client devices in conjunction with a federated machine learning process, wherein at least a portion of the data comprises encoded private data and at least a portion of the data is public data;
generating a spatio-temporal graph comprising nodes representing the plurality of distributed client devices, wherein the generating comprises identifying at least one pair of similar nodes based at least in part on the public data and adding an edge to the spatio-temporal graph between the pair of similar nodes; and
aligning encoders of at least two of the distributed client devices based at least in part on the spatio-temporal graph;
wherein the method is carried out by at least one computing device.

2. The computer-implemented method of claim 1, wherein the encoders of the at least two of the distributed client devices produce embeddings of the private data in different vector spaces.

3. The computer-implemented method of claim 1, wherein a given one of the plurality of distributed client devices comprises a machine learning model that generates a prediction based at least in part on embeddings output by an encoder of the given client device.

4. The computer-implemented method of claim 1, wherein the aligning comprises:
applying a negative sampling process based at least in part on pairs of similar nodes that are identified in the spatio-temporal graph.

5. The computer-implemented method of claim 1, wherein the aligning comprises:
generating a random data sample;
sending the random data sample to a first one of the plurality of distributed client devices;
receiving an encoded version of the random data sample from the first distributed client device; and
sending the encoded version and the random data sample to a second one of the plurality of distributed client devices, wherein the second distributed client device aligns its encoder based at least in part on the encoded version and the random data sample.

6. The computer-implemented method of claim 1, wherein the aligning comprises:
applying a projection function to the encoded private data of a given one of the distributed client device; and
adding the output of the projection function as a feature to the node corresponding to the given distributed client device.

7. The computer-implemented method of claim 1, wherein the aligning comprises:
providing the encoded private data of a first one of the distributed client devices and the public data of a second one of the distributed client devices as input to a discriminator model to determine one or more alignment gradients; and
sending the alignment gradients to at least one of the first and the second distributed client devices.

8. The computer-implemented method of claim 1, wherein the aligning comprises:
processing the spatio-temporal graph using a graph neural network.

9. The computer-implemented method of claim 1, wherein the method is carried out by a central server in a message passing architecture.

10. The computer-implemented method of claim 1, wherein software is provided as a service in a cloud environment for performing at least a portion of the federated learning process.

11. A computer program product comprising a computer readable storage medium having program instructions embodied therewith, the program instructions executable by a computing device to cause the computing device to:
obtain temporal data from a plurality of distributed client devices in conjunction with a federated machine learning process, wherein at least a portion of the data comprises encoded private data and at least a portion of the data is public data;
generate a spatio-temporal graph comprising nodes representing the plurality of distributed client devices, wherein the generating comprises identifying at least one pair of similar nodes based at least in part on the public data and adding an edge to the spatio-temporal graph between the pair of similar nodes; and
align encoders of at least two of the distributed client devices based at least in part on the spatio-temporal graph.

12. The computer program product of claim 11, wherein the encoders of the at least two of the distributed client devices produce embeddings of the private data in different vector spaces.

13. The computer program product of claim 11, wherein a given one of the plurality of distributed client devices comprises a machine learning model that generates a prediction based at least in part on embeddings output by an encoder of the given client device.

14. The computer program product of claim 11, wherein the aligning comprises:
applying a negative sampling process based at least in part on pairs of similar nodes that are identified in the spatio-temporal graph.

15. The computer program product of claim 11, wherein the aligning comprises:
generating a random data sample;
sending the random data sample to a first one of the plurality of distributed client devices;
receiving an encoded version of the random data sample from the first distributed client device; and
sending the encoded version and the random data sample to a second one of the plurality of distributed client devices, wherein the second distributed client device aligns its encoder based at least in part on the encoded version and the random data sample.

16. The computer program product of claim 11, wherein the aligning comprises:
applying a projection function to the encoded private data of a given one of the distributed client device; and
adding the output of the projection function as a feature to the node corresponding to the given distributed client device.

17. The computer program product of claim 11, wherein the aligning comprises:
providing the encoded private data of a first one of the distributed client devices and the public data of a second one of the distributed client devices as input to a discriminator model to determine one or more alignment gradients; and
sending the alignment gradients to at least one of the first and the second distributed client devices.

18. The computer program product of claim 11, wherein the aligning comprises:
processing the spatio-temporal graph using a graph neural network.

19. The computer program product of claim 11, wherein the computing device corresponds to a central server in a message passing architecture.

20. A system comprising:
a memory configured to store program instructions;
a processor operatively coupled to the memory to execute the program instructions to:
obtain temporal data from a plurality of distributed client devices in conjunction with a federated machine learning process, wherein at least a portion of the data comprises encoded private data and at least a portion of the data is public data;
generate a spatio-temporal graph comprising nodes representing the plurality of distributed client devices, wherein the generating comprises identifying at least one pair of similar nodes based at least in part on the public data and adding an edge to the spatio-temporal graph between the pair of similar nodes; and
align encoders of at least two of the distributed client devices based at least in part on the spatio-temporal graph.
